(19) United States
(12) Patent Application Publication
(10) Pub. No.: US 2022/0203467 A1
(43) Pub. Date: Jun. 30, 2022

(54) REMOTE CONTROL OF A PORTABLE AUTOMATED CUTTER

(71) Applicant: Kobots ApS, Odense S (DK)

(72) Inventor: Yonas ALIZADEH, Odense SØ (DK)

(73) Assignee: Kobots ApS, Odense S (DK)

(21) Appl. No.: 17/606,325

(22) PCT Filed: May 1, 2020
(86) PCT No.: PCT/DK2020/050126

§ 371 Date: Oct. 25, 2021

(30) Foreign Application Priority Data
May 1, 2019 (DK) PA 2019 70277
May 1, 2019 (DK) PA 2019 70281
Oct. 17, 2019 (DK) PA 2019 70648

(51) Int. Cl. B23D 59/00; B27B 5/07; B23D 47/02; G01B 3/1092; G01B 3/1094

(52) U.S. Cl. CPC B23D 59/002; B27B 5/07; G01B 3/1094; G01B 3/1092; B23D 47/02

(57) ABSTRACT

The invention relates to a method of remote control of a portable automated cutter comprising a power cutter. The position of the power cutter is controlled by a controller based at least partly on input provided by a user via an intelligent measuring tape. The intelligent measuring tape comprising a distance sensor, an orientation sensor, a micro-controller and a user interface comprising a communication element. The user is extracting tape from the intelligent measuring tape enclosure along at least one part of a representation of a cutting off, the distance sensor establishing a linear measure of the length of the extracted tape, by activating the communication element, the user facilitates wireless communication of the established linear measure from the micro-controller to the controller, and upon receiving the linear measure, the controller controls the power cutter according to the established linear measure.

### FIELD OF THE INVENTION

The invention relates to a method of communication between an intelligent measuring tape and portable automated cutter, an intelligent measuring tape and to a portable automated cutter system.

### BACKGROUND OF THE INVENTION

A majority of board cuts made by construction workers on construction sides can be made with a manual or automated cutter. Known cutters are typically stationary having a complex design and therefore not suitable for use in one construction site after the other i.e. not suitable for assembling and dismantle. Examples of such cutters of the panel type can be found in EP1952957 and EP2143517.

Known panel cutter suitable for assembling and dismantling are typically manually or semi-automated requiring a user to operate it where it is located. Examples hereof can be found in U.S. Pat. Nos. 4,802,399 and 7,779,737.

Hence prior art cutters suffer from lack of either flexibility in place of use and/or requires manual operation to cut.

### SUMMARY OF THE INVENTION

The invention relates to a method of remote control of a portable automated cutter (1) comprising a power cutter (13),

wherein the position of the power cutter (13) in X, Y and Z directions relative to a board to be cut (42) and the orientation in an angle φ around the Z direction, is controlled by a controller (20), controlling motors (8, 11, 16, 19) based at least partly on input provided by a user via an intelligent measuring tape (53),

wherein the method of remote control of the cutter (1) comprises the steps of:
establishing a wireless communication channel (39) between the intelligent measuring tape (53) and the controller (20), wherein the intelligent measuring tape (53) comprising:
   a. a distance sensor (54) establishing information of a distance
   b. an orientation sensor (62) communicating with the micro-controller (57) establishing information of orientation of the measured distance
   c. a micro-controller (57) communicating with the distance sensor(s) (54) and with the controller (20), and
   d. a user interface (58) comprising a communication element (59a),
the distance sensor (54) establishing a linear measure of the distance,

by activating the communication element (59a), the user facilitates wireless communication of the established linear measure from the micro-controller (57) to the controller (20), and

upon receiving the linear measure, the controller (20) controls the motors (8,11,16,19) and the power cutter (13) according to the established linear measure resulting in the automatic cut of a cutting off in the board to be cut (42) matching the measured representation of the cutting off

The invention relates to a further method of remote control of a portable automated cutter comprising a power cutter, wherein the position of the power cutter in X, Y and Z directions relative to a board to be cut and the orientation in an angle φ around the Z direction, is controlled by a controller, controlling motors based at least partly on input provided by a user via an intelligent measuring tape, wherein the method of remote control of the cutter comprises the steps of:
establishing a wireless communication channel between the intelligent measuring tape and the controller, wherein the intelligent measuring tape comprising:
   a distance sensor establishing information of the length of tape extracted from the intelligent measuring tape enclosure,
   an orientation sensor communicating with the micro-controller establishing information of orientation of the intelligent measuring tape enclosure,
   a micro-controller communicating with the distance sensor(s) and with the controller, and
   a user interface comprising a communication element,
the user extracting tape from the intelligent measuring tape enclosure along at least one part of a representation of a cutting off,
the distance sensor establishing a linear measure of the length of the extracted tape,
by activating the communication element, the user facilitates wireless communication of the established linear measure from the micro-controller to the controller, and
upon receiving the linear measure, the controller controls the motors and the power cutter according to the established linear measure resulting in the automatic cut of a cutting off in the board to be cut matching the measured representation of the cutting off

In the present context, and within the scope of the invention, a distance may be measured alternatively by means of non-contact measurement. In such an implementation, the distance would be measured e.g. by means of ultrasonic or laser measurement devices. In the case of a laser measurement device, the user of the intelligent measuring tape may simply activate the laser distance sensor by pointing at one end of the relevant measuring points (when measuring a kind of 1D measurement where the measuring tape device as such defines one end the distance to be measured and where the other point is defined as the point towards where the laser beam points. The device, method and system will still work according to advantageous provisions of the invention where the obtained laser measure (as an alternative to the measure obtained via digital reading of the strip is applied inventively in the communication with the automated cutter, i.e. by easily/effectively mapping 1D distance measures at measured orientations into a 2D or 3D cutting of a board to be cut. This is partly obtained by the invention use of a number of single measures into a 2 (or 3D) definition of how to cut the board.

It should here be noted that the linear measure between point A and point B may also, within the provisions of the invention be established by a non-contact distance measuring device, e.g. by means of a laser measurement device. The skilled person would of course in such a situation not need to have a measurement device including a physical strip (tape) and simply operate the non-contact measurement device as he or she is used to in order to establish the relevant distances and then transmit them to be processed by the controller of the system into the desired 2D (optionally 3D) cut of the board (including the orientation). This also applied to any embodiment described in the present application as the inventive application of a remote measurement is advantageous, being applied with a measuring tape including a physical measuring tape or not.

In other words, within the terminology of the invention an intelligent measuring tape or a measuring tape enclosure is hereby broadened to also include non contact measuring devices such a laser distance meters as long as such strip-free application establishes and applies the measured distances according to the inventive concepts. This may from the start be somewhat confusing, but by this and supplementary statements in the applications, any confusion as what a measuring tape actually designates is hereby eliminated. The measuring tape will only include a physical strip if mentioned. If such a strip is not specifically mentioned, the meaning of a measuring tape will be intended to cover both a physical use/implementation of a strip and/or a pure non-contact measurement of the relevant distance.

The board to be cut should be understood as the board that is placed on the automatic cutter and from which the cutting off is made. The cutting off should be understood as the part that is cut out of the board to be cut. The cutting off could refer either to the part that is to be used to cover the representation of the cutting off or the part that is to be discarded making the remaining of the board to be cut to the part that is to be used to cover the representation of the cutting off

The controller may initiate cutting upon receiving the measures needed to perform a cutting. However, for safety reasons, it may be preferred that the cutting first is initiated when the user allows so e.g. by activation of the communication device in a predetermined sequence or length of time (two subsequently activations within 1 second or similar).

The representation of a cutting off should be understood as the area which is measured, and which is to be covered by the cutting off cut in the board to be cut by the portable automated cutter. Accordingly, a representation of a cutting off could be a complete wall or any parts of such wall that is to be covered by the cutting off cut in the board to be cut by the portable automated cutter. The representation of a cutting off could furthermore be one or more parts of a cover hiding a girder, inside diameter of a window opening, etc.

The communication element of the user interface is of the intelligent measuring tape is preferably one or more buttons via which the user can control the intelligent measuring tape. The control can be adjusting from where of the intelligent measuring tape, the linear measure starts, if a measure should be stored/communicated, SI units of the measurement, etc. The user can change such and other settings by different combinations of short and long activation of the buttons and different combination of activation of the first and second buttons.

Using the intelligent measuring tape is advantageous in that it has the effect that when established by a user, measures are automatically communicated to the controller. Thereby, the user does not need to write down or memorise measurements reducing the risk of human errors related to the steps of cutting a cutting off which makes the work of the user more efficient and leading to a reduction of wrong cutting offs that needs to be discarded.

This is advantageous in that it has the effect, that the orientation in space of the linear measure, particularly in the X and Y plane of the board to be cut can be established. Accordingly, both the linear measure and orientation in space hereof is communicated from the micro-controller to the controller of the portable cutter preferably via the portable user device.

In fact, having an orientation sensor enables the measuring tape to measure a 3D shape i.e. provide measures for a geometric form in both X, Y and Z directions and provide measures hereof to the controller of the portable cutter which then cuts the 3D shape either in one piece or several pieces. If the orientation sensor is using a magnetometer (MARG 9-axis) then the orientation is obtained with respect to earth gravitational field. If the orientation sensor is not using a magnetometer, but only an accelerometer and/or gyroscop (standard IMU 6-axis) then the orientation is obtained with respect to Z orientation with relative to the start-orientation of the measuring tape.

A portable automated panel cutter should be understood as a saw or cutter that can be automatically controlled i.e. preferably no manually handling of the cutter is required during the cutting operation (manual handling of object to be cut would typically be required). A portable automated panel cutter is in an embodiment understood as a panel cutter but could also be implemented as a dragknife preferred for cutting e.g. gypsum boards or end cutters for cutting e.g. laths or battens.

According to an embodiment, the method further comprises the step of
assembling a support frame defining an inner support area, the support frame being releasably assembled by a plurality of frame profile,
movably mounting a carriage to a first and second of the plurality of frame profiles of the support and thereby being movable over the inner support area, and
releasably mounting a power cutter to the carriage.

This is advantageous in that it has the effect, that the portable automated cutter is usable also in areas where space or access is limited e.g. by doors or stairs.

Moreover, the invention relates to an intelligent measuring tape comprising:
a distance sensor establishing a distance e.g. measured by a laser measuring sensor/transmitter,
an orientation sensor communicating with the micro-controller establishing information of orientation of the distance,
a micro-controller communicating with the distance sensor(s) and with a controller of a portable automated cutter, and
a user interface comprising a communication element,
wherein the distance sensor is implemented as an optical sensor, a rotary sensor or magnetic distance sensor

Moreover, the invention relates to an intelligent measuring tape comprising:
a distance sensor establishing information of the length of tape extracted from the intelligent measuring tape enclosure,
an orientation sensor communicating with the micro-controller establishing information of orientation of the intelligent, measuring tape enclosure,
a micro-controller communicating with the distance sensor(s) and with a controller of a portable automated cutter, and
a user interface comprising a communication element,
wherein the distance sensor is implemented as an optical sensor, a rotary sensor or magnetic distance sensor.

The optical sensor may be used to scan markers on the measuring tape and is advantageous in that it has the effect, that it is simple to attach mechanically, and it is low in cost. The optical sensor may be referred to as a barcode scanner.

The rotary sensor may be based on light or magnetism, the rotation may be detected via holes or magnetic poles detected e.g. by an optical sensor or a Hall-Effect sensor. The output is a so-called quadrature signal showing the direction of rotation and the amount. Alternatively, the distance can be determined by the so-called Magnetic Field Angle Sensor.

According to an embodiment, the orientation sensor is an Inertial Measuring Unit establishing the orientation of the intelligent measuring tape enclosure.

An inertial measuring unit is advantageous, in that I collects linear acceleration and angular velocity. The Inertial Measuring Unite is a type of Micro Electro-Mechanical system. In an alternative embodiment, the orientation is established by a Magnetic, Angular Rate and Gravity sensor incorporating a magnetometer. Based on the output of the IMU it is possible to obtain the orientation of the device with respect to the gravitational field of the earth and a calibration starting point for the Z-axis.

According to an embodiment, wherein the orientation sensor comprises an accelerometer and a gyroscope.

This is advantageous in that it has the effect, that non-gravitational acceleration and/or orientation (relative to Earth's gravity or Z-orientation) of the measuring tape can be determined. The accelerometer may be one, two or three axis accelerometers.

This is advantageous in that it has the effect that an angel between a first linear measure and a subsequent linear measure can be established. Thereby, it is possible for the user to measure up a geometry of a cutting off without this geometry being predetermined by a predetermined cutting off

According to an embodiment, the intelligent measuring tape further comprises a data memory communicating with the micro-controller.

This is advantageous in that it has the effect, that various measures obtained by the distance and orientation sensors can be stored at least until the wireless communication channel is established or re-established after a fault. Typically, the obtained measures are communicated directly to the controller upon activating the communication element, however the measures may be temporary stored in the data memory before communicated.

According to an embodiment, the user interface comprises a display.

This is advantageous in that it has the effect, that the length of the extracted part of the measuring tape can be provided to the user as well as the orientation of the measuring tape enclosure.

The communication element is advantageous in that it has the effect, that when a measurement is taken, the readings received by the micro-controller the communication element can be used to allow the micro-controller to send the measurement to the controller.

This is advantageous in that it has the effect, that the user is able to, on the intelligent measuring tape, see the length measured and when satisfied initiate communication of this measurement.

According to an embodiment, the distance measurement and the orientation measurement are measured and stored in the data memory simultaneously upon activating the communication element.

According to an embodiment, the wireless communication channel from the intelligent measuring tape to the controller is established via a portable user device.

In an embodiment, the portable user device is a smartphone or tablet comprising an application which is developed to receive information from the intelligent measuring tape and to send information to the controller.

This is advantageous in that it has the effect, that measurements made by the intelligent measuring tape is communicated to the portable user device where the measurements can be manipulated before communicated to the controller (of the portable cutter)

According to an embodiment, the method further comprises the step of via the portable user device or via the measuring tape prompting the user for required measurements.

This is advantageous in that it has the effect, that measurements needed for the portable cutter is able to cut a given representation of a cutting off are all provided. Hence, the cutting process is not interrupted by a user not remembering a to take a measure. Further, if the controller/portable user device finds that the representation of the cutting off is too large to be in one board to be cut, the line of fastening points e.g. where a latch is in a wall is important information when determining where to separate one representation of a cutting off into two cutting offs.

According to an embodiment, the micro-controller processes the sensor data and facilitates communication hereof via Bluetooth, Wi-Fi or Near Field Communication to the portable user device.

This is advantageous in that it has the effect, that wireless communication between the intelligent measuring tape and the portable user device, which in an embodiment is a smartphone, is possible. Preferably all processing of data is facilitated in the portable user device, hence in an embodiment, the intelligent measuring device is only collecting data and transmitting data.

According to an embodiment, the portable user device comprises a user interface via which the user is allowed to review and modify measurements received from the intelligent measuring tape before the user via the portable user device allows the controller to initiate the cutting operation.

This is advantageous in that it has the effect that the user is able to review and if needed adjust measures received from the intelligent measuring tape before the user initiates the cutting. The review or modification is made via an application the user can communicate with via the display of the portable user device either by interacting via voice or touching the display.

According to an embodiment, the portable user device provides access to a plurality of user selectable predetermined cutting offs, each of which is defined by at least one predetermined measure type,
wherein the user is selecting at least one predetermined cutting off and via the intelligent measurement tape establishing required measures corresponding to the at least one predetermined measure type.

A predetermined cutting off should be understood as a template for a geometric form that can be cut by the portable cutter. The predetermined cutting off can be used either as the cutting of that is needed to cover the representation of the cutting off or the excess part of a complete board to be cut that when this excess part is removed, covers the representation of the cutting off. The predetermined cutting offs are typically accessible via an application installed on the portable user device.

The predetermined cutting off is defined by one or more measure types such as left side, right side, top, bottom, hole, etc. (with reference to the board to be cut). Accordingly, for each of the required measuring types a length must be measured. The length may be defined as the distance between reference points which are typically defined only in the X and Y plane and serves as starting point and end point for a cut made by the cutter in the board to be cut. Therefore, when the user has selected a predetermined cutting off via the application on the portable user device, the application is simply waiting for the length of the measure of the required measuring types to be provided in a predetermined sequence.

Using predetermined cutting off is advantageous in that it has the effect, that the measure types needed to define a predetermined cutting off are also predetermined and therefore it is possible to provide measures hereof automatically to the portable user device in a predetermined sequence. Hence as these measures are made, they can automatically be sent from the measuring tape to the portable user device where they are automatically loaded into the predetermined cutting off. Subsequently, the user can verify the received measures on the display of the portable user device before updating the controller with the information required to perform a cut and before initiating such cut.

With this said, the predetermined cutting off could also be a freeform cutting off which geographical form is designed by measures as these measures are made from point to point and provided to the portable user device. Typically, these measures are made on the representation of the cutting off. It should be mentioned, that the free form predetermined cutting off requires an orientation sensor as described below.

According to an embodiment, the measure of at least one of the required measure types of a selected predetermined cutting off is derived from one or more of the previous measures.

This is advantageous in that it has the effect, that measuring up a cutting off is made faster compared to normal manual measuring up, in that at least one measure in this embodiment is automatically calculated. If the cutting off is a right-angled triangle, only the measure of one side (measure type) and the angle between that side and the adjacent side is enough to calculate the remaining measures and thereby information sufficient for the portable automated cutter to cut the cutting off

According to an embodiment, the selection of predetermined cutting offs includes specifying if the cutting off is a right-angled geometric shape.

This is advantageous in that it has the effect, that the controller then is able to calculate the complete cutting off before all sides of the cutting off is measured up

According to an embodiment, the measuring tape furthermore comprises a microphone.

This is advantageous in that it has the effect, that user can communicate via voice commands to the cutter without the need of a headset connected to the portable user device or without communication directly to the portable user device.

According to an embodiment, the communication device is implemented as a plurality of buttons

This is advantageous in that it has the effect, that the measuring tape can have multiple functions without requiring to remember several different activation patterns of a single button.

According to an embodiment, the communication element facilitates change of mode of operation between measuring a linear measure by means of the measuring tape or by means of a laser measuring device.

This is advantageous in that it has the effect, that by a simple activation of one of the buttons or a predetermined sequence of activation of one or more of the buttons it is possible to change the way the measure is obtained by the measuring tape.

According to an embodiment, the communication elements is used to determine a predetermined cutting off.

This is advantageous in that it has the effect, that all necessary steps to make the automated cutter cut can be performed from the measuring tape. Thereby the user does not first need to choose a predetermined cutting off via the portable user device, measure by the measuring tape, verify the measure via the portable user device and finally send accepted measures to the controller of the cutter. In this way he has both hands free to handle the measuring tape.

According to an embodiment, the function of the plurality of buttons are reconfigurable.

This is advantageous in that it has the effect, that the measuring tape can be 100% individualised and thereby its functions can be managed by the user.

According to an embodiment, each of the plurality of buttons are multifunctional according to a predetermined activation pattern.

This is advantageous in that it has the effect, that a plurality of functions can be applied to the measuring tape even though only two or three buttons are implemented and thereby the design of the measuring tape is not changed. A predetermined activation pattern could e.g. be holding one button down while activating another button one or more times. It could also be a series of activations of a button.

According to an embodiment, at least two buttons are implemented at the same side of the enclosure.

According to an embodiment, at least one button is implemented at an upper left corner of one side of the enclosure and wherein the display is implemented on the side adjacent to the one side of the enclosure.

According to an embodiment, at least one button is implemented at an upper right corner of the one side of the enclosure.

This is advantageous in that it has the effect, that when the user is holding the measuring tape enclosure in his left and/right hand to look at the display, his thumb is automatically place over one of the buttons of the upper left or right corners of the one side of the enclosure. Thereby, the measuring tape is easy to operate with one hand without the risk of dropping it. In an embodiment, one of the buttons of the upper left or right corners is an “OK” button via which the user can accept a selection made by another button.

According to an embodiment, at least one of the buttons are implemented as scroll wheel.

This is advantageous in that it has the effect that the scrolling down through the different options/menus can be made fast and easy.

According to an embodiment, activation of a button after a period of time wake up the measuring device and/or the application on the portable user device.

A wakeup function on the measuring tape is advantageous in that it has the effect, that battery consumption is reduced during time when the measuring tape is not in use. Further, by activating a button of the measuring tape enclosure a signal may be sent to the portable user device and/or to the controller of the cutter thereby waking up the entire system.

According to an embodiment, the display displays to the user a subset of the available options displayed to the user from the portable user device.

This is advantageous in that it has the effect, that the portable use device does not need to be used by the user to perform a cutting off by the portable automatic cutter. In this situation, the portable user device more or less functions as a communication hub between the measuring tape and the cutter passing measurements receive e.g. via NFC or Bluetooth from the measuring tape on to the controller of the cutter e.g. via WiFi.

Moreover, the invention relates to a measuring system comprising a portable automated cutter, a portable user device and an intelligent measuring tape, the measuring system comprises
a measuring interface implemented as a distance sensor and an orientation sensor as part of the intelligent measuring tape,
a first communication device as part of the intelligent measuring tape and a second communication device as part of the portable user device,
wherein the intelligent measuring tape facilitates control of dimensions of a cutting off to be cut by the portable automated cutter.

According to an embodiment, the dimension control includes providing measures obtained by the intelligent measuring tape to the portable automated cutter via the portable user device.

According to an embodiment, the portable automated cutter is started from the intelligent measuring tape or from the portable user device.

Moreover, the invention relates to a portable automated cutter system comprising a portable automated cutter and an intelligent measuring tape,
the intelligent measuring tape comprises
   a distance sensor establishing information of the length of tape extracted from the intelligent measuring tape enclosure,
   an orientation sensor communicating with the micro-controller establishing information of orientation of the intelligent, measuring tape enclosure,
   a micro-controller communicating with the distance sensor(s) and with a controller of the portable automated cutter, and
   a user interface comprising a communication element,
the controller is configured for automatically starting and controlling cutting operation of a power cutter removably connected to the portable automated cutter based on measures received from the intelligent measuring tape.

The system is advantageous in that it has the effect, that it allows cutting of a board to be cut automatically solely based on information received from the intelligent measuring tape. Hence, no measures or readings are needed on, off or from the portable automated cutter to perform cutting operations of a board to be cut. Accordingly, the portable automated cutter system is less affected by dust on reading points as is the case in prior art systems as well as by bumps which in prior art systems could require recalibration of sensor systems. This is advantageous when the system is used in construction sites where dust and bumps are expected.

According to an exemplary embodiment of the invention, the portable automated panel cutter is collapsible. This is advantageous in that it has the effect, that the portable automated panel cutter is collapsible and thereby be folded into a small space and unfolded at the construction site without significant mounting effort from the user.

According to an exemplary embodiment of the invention, the portable automated panel cutter is at least partly collapsible. This is advantageous in that it has the effect, that the portable automated panel cutter is at least partly collapsible and thereby be at least partly folded into a small space and unfolded at least partly at the construction site without significant mounting effort from the user.

According to an exemplary embodiment of the invention, a cutting tool of the power tool is a sawblade.

### THE DRAWINGS

For a more complete understanding of this disclosure, reference is now made to the following brief description, taken in connection with the accompanying drawings and detailed description, wherein like reference numerals represent like parts:

FIG. 1 illustrates a dismantled portable automated panel cutter,

FIG. 2 illustrates an assembled portable automated panel cutter,

FIG. 3 illustrates an intelligent measuring tape and a representation of a cutting off,

FIG. 4 illustrates a flow diagram of operating the intelligent measuring tape,

FIG. 5 illustrates a representation of four cutting offs, and

FIG. 6 illustrates an intelligent measuring tape comprising user interface.

### DESCRIPTION

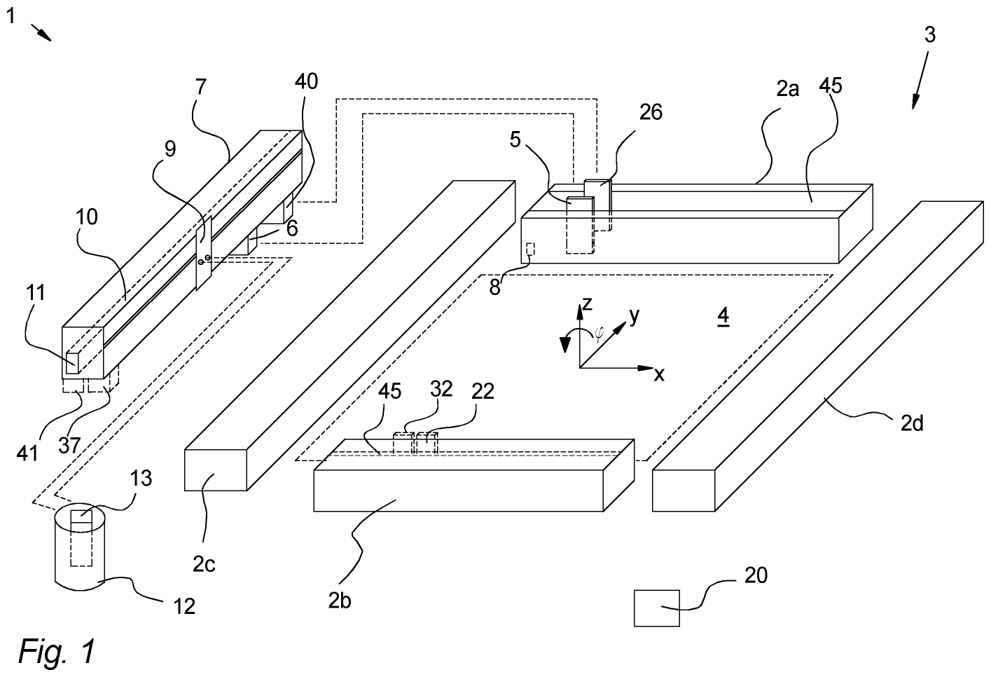

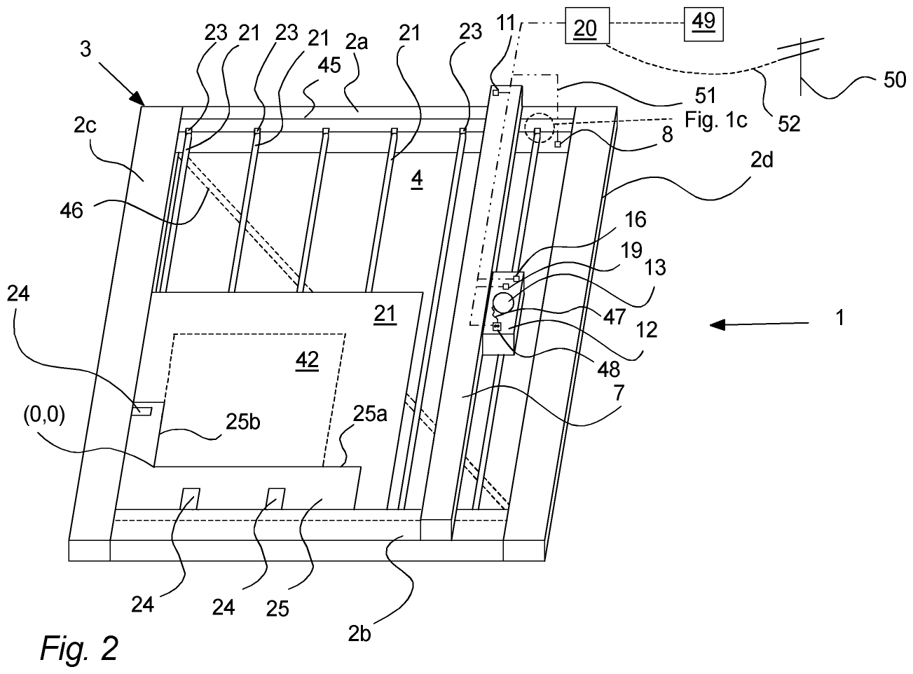

In the following description, the invention is described with reference to a cutter of the panel cutter type illustrated on FIGS. 1 and 2. It should be underlined, that the present invention is applicable to other types of portable automated cutters as described above, hence when reference in the following description is made to a portable automated panel cutter the invention is not limited so this particular type of portable automated cutter.

FIG. 1 illustrates dissembled parts of a portable automated panel cutter 1 and FIG. 2 illustrates an assembled panel cutter 1 according to an embodiment of the invention. The panel cutter 1 is portable meaning that it can be packed away e.g. in bags when not in use. Accordingly, the panel cutter 1 is advantageous in that when it is not in used it can literally be stored on a shelf at a workshop or similar. When needed again it is easy to carry the dismantled panel cutter 1 to the site where it is needed. Further, craftsmen such as carpenter and bricklayers are often carrying a lot of building materials during the day. To protect their body, they are advised not to carry more than 14-20 Kg at the time. Therefore, the panel cutter 1 of the present invention is advantageous in that it can be dismantled in various parts which does not exceed the recommended weight.

The panel cutter 1 comprises a support frame 3 that is built from four frame profiles 2a-2d. Attachable to the support frame 3 via first and second carriage transmission part 5, 6, and first carriage bearing and receiver 26, 40 through a longitudinal opening 45 in the top profile 2a is a carriage 7 and attachable to a tool holder carriage 9 of the carriage 7 is a tool holder 12. The carriage 7 may as indicated also be connected to the bottom profile 2b here indicated by first carriage bearing receiver 40 and a longitudinal opening 45. Finally, attachable to the tool holder 12 is a power cutter 13. The inner support area 4 defined by the four frame profiles 2a-2d is at least partly covered by board support 21 supporting a board 42 to be cut (see FIG. 2).

A controller 20 is controlling the operation of the panel saw 1 via input data received from a user. A user can be any person that needs to cut material. Carpenters and bricklayers are examples of persons that during a working day are cutting a lot of boards 42 and hence would benefit from an automation of their cutting processes. The movement of the carriage in the X direction is facilitated by control of a motor 8 mechanically connected to the first carriage transmission part 5. The movement of the tool holder 12 in the Y direction is facilitated by control of a motor 11 mechanically connected to a first tool holder drive part 10.

FIG. 2 illustrates an assembled panel cutter 1. In this embodiment, the board support 21 is in the form of both slats and a board. The board 42 to be cut is illustrated by stipulated lines on top of the board support 21. As an alternative or in addition to the slats, the board support can be in form of a diagonal support 46 (stipulate on FIG. 2) which when mounted not only increases the stiffness/rigidness of the support frame 3 but also can be used as board support. Hence, board support in the form of a board resting on the diagonal support 46 and preferably also on one or more board support fixations 23 can be used to support the board 42. In this way, the mounting of the support frame can be made faster.

The panel cutter 1 is supplied with power from a power supply which in an embodiment is the voltage of the utility grid 50 obtained from power supply cables 52 connecting the panel cutter 1 to the utility grid 50. It could also be supplied from an energy storage 49 in the form of one or more batteries. Motor power supply cables 51 are preferably connecting the motors 8, 11, 16, 19 to the power supply 49, 50 and the controller 20 is controlling the current in these motor power supply cables 51 to facilitate the desired movement of the parts of the panel cutter 1.

In an embodiment, the tool holder 12 is equipped with a power socket 48 to which the electric wire from the power cutter 13 is connected. In this way the power cutter 13 can be controlled by controlling power to the power socket 48. The power socket 48 may also have other locations on the panel cutter 1, however the location on the tool holder 12 is preferred.

Hence, in this context the term “panel cutter” should be understood as a machine for cutting or sawing sheets into predetermined dimensions and/or numbers e.g. on a horizontal plane, slanted plane or vertical plane.

The orientation of the board 42 on the panel cutter i.e. which side/end of the board is left, right, top and bottom can be defined in software of the controller. Measures are typically made from left to right and from bottom to top. Accordingly, the measures provided to the controller 20 is handled according to the determined orientation of the board 42 orientated on the board support 21.

In this document, a board 42 should be understood widely including any kind of lumber that can be cut by a power cutter as described below. Further, a board in this document also includes other materials than lumber, hence a board 42 should be understood as any of the following materials plywood, chipboard, gypsum, medium-density fibreboard, concrete, (precast) masonry, clinker, steel, fiber-cement board, etc.

The preferred position of the frame 3 and thereby of the panel cutter 1, when the panel cutter 1 is in operation is in an upright position at least 10 degrees from vertical (this angle is in this document referred to as theta 0). This is because the handling of boards 42 to be cut is easier if they can be placed on/removed from the panel cutter 1 in the same orientation as lifted which are typically in an orientation close to vertical. A further advantage in positioning the frame 3 in an upright position is that gravity helps positioning/fixing the board 42 at a desired location with reference to the frame. In an embodiment the panel cutter 1 is positioned upright supported against a wagon which are typically used for transporting and storing e.g. gypsum boards. Other ways of supporting the frame 3 such as a wall, a table, etc. could also be used.

The power cutter 13 is a standard handheld power cutter which when not mounted in the panel cutter 1 can be used for standard handheld power cutting. In this context, the term “power cutter” should be understood as an angle grinder, circular saw, jigsaw or other type of handheld cutting device. The power cutter 13 comprises a “cutter tool” in the form of e.g. a saw blade, grinder blade, jigsaw blade or any other kind of cutting tool for attachment to a power cutter 13 and thereby facilitating cut or saw of a material by conducting a circulating, oscillating or reciprocating motion.

The power cutter 13 may be powered when a user has initiated a cutting operation. Preferably, the controller 20 is controlling the power supply to the power cutter 13 via a relay. The relay controls power to a power socket located on the panel cutter 1, to which the plug of the power cutter 13 (and e.g. also a vacuum cleaner) is connected. In this way, when the controller 20 powers up the power socket, power is supplied to the power cutter 13 which is then turned on. As one can understand, the embedded power switch normally turning the power cutter 13 on is in its on position when the power cutter 13 is mounted in the tool holder 12 for this way of turning on and off the power cutter is possible. The same is true for the power switch of the vacuum cleaner if that is used for preventing small particles from the cutting to pollute the air around the panel cutter. The power socket may also be located e.g. on the control box and powering the power cutter 13 via an extension cord.

Depending on the instructions provided by the user for where on the board 42 the cut has to be made, the controller 20 then controls the motors 8, 11, 16, 19 and thereby the movement of the power cutter 13 in the X, Y, Z and φ directions. As can be understood this control includes operation of more than one motor at the time to be able to perform e.g. a slanting cut i.e. one definition of automated is that e.g. the motors controlling the movement of the power cutter in the X and Y direction are operated simultaneously. The speed of the individual motors is not necessarily the same, the speed depends e.g. of the inclination of a slanting cut.

It should be mentioned that the controller 20 may be an industrial programmable logic controller or a cloud-based controller i.e. the panel cutter 1 does not have a physical controller in the latter situation. In this embodiment, the user communicates wirelessly with the cloud-based controller which again communicate wirelessly with the power cutter 1. This is advantageous in that then it is easy to update the control software on the panel cutters, however it requires a stabile wireless (internet) connection to operate the panel cutter 1.

The controller 20 receives input from a user in terms of size and geometry of the board that is needed i.e. that is cut from the board 42 (also sometimes referred to as a cutting off). Hence, e.g. on a wall or floor to be built, from a drawing, etc. the user establishes measures of geometry of a board needed to cover a specific area (also sometimes referred to as a representation of a cutting off). These measures preferably include one of the following length right side, length left side, length top and length bottom. When one or more of these measures are established, they are provided to the controller 20. The controller 20, based on the received input, then controls the motors 8, 11, 16, 19 and thereby the position and orientation of the power cutter 13 and powers on the power cutter 13 to cut a board complying with the established measures.

The user may communicate to the controller e.g. via a screen or display, buttons, voice, touch panels/screens, etc. The measures may be provided to the controller 20 via predetermined templates (also referred to as user selectable predetermined cutting offs) prepared for receiving particular measures in a particular sequence.

The user interface may be part of the panel cutter 1 or may be a portable user device 61 communicating with the controller 20 via a wireless communication channel 39 or it may be an intelligent measuring tape or a combination hereof. In an embodiment, the communication of measures is established directly from the intelligent measuring tape to the controller 20. In another embodiment, the intelligent measuring tape is communicating measures to the portable user device 61 and from this device, the measures (or modified measures) are communicated to the controller 20. The portable user device 61 may be a tablet or a smartphone having appropriate software for receiving, modifying and communicating the measures to the controller 20.

Hence, since the device used for communication between the user and the controller 20 of the panel cutter 1 is a portable such as a smartphone or a measuring tape, this enables controlling the panel cutter 1 from a location remote to the panel cutter 1. Such remote location may be an area such as a room next to the area or room in which the panel cutter 1 is located. The possibility of remotely controlling the panel cutter increases the efficiency of the user e.g. in that time spend walking from where measures are established to the panel cutter 1 is used on cutting a board by the panel cutter 1. Further, time spend on marking on the board where to cut with a power cutter 13 (not mounted in the panel cutter 1) is eliminated when cutting with automated power cutter 1.

When communicating with the panel cutter 1, the user provides instructions and measures to the panel cutter. In embodiments, the panel cutter 1 sends back to the user the information received for the user to be able to verify it. The individual pieces of the communication from the panel cutter 1 to the user may be disabled to make the control of the panel cutter more user friendly. I.e. it is up to the user to determine which information that he would like to be able verify prior to cutting with the panel cutter 1.

It should be mentioned, that the step of establishing the communication channel 38 may include the step of user identification. Hence the user, prior to providing information to the panel cutter 1 is identifying himself e.g. by communicating a password and/or a username to the panel cutter 1. Alternatively, or in addition, the user identification may be used each time, the user is going to use the panel cutter.

The communication with the controller 20 is preferably limited to follow a number of predetermined standards or templates referred to in this document as so-called user selectable predetermined cutting offs. Each cutting off is predetermined and selectable via the portable user device 61 having access to a cutting off database. The cutting off database may be an online database or embedded in data storage of the controller 20.

The intelligent measuring tape 53 is intelligent in that it comprises micro-controller 57, distance sensor 54, orientation sensor 62 and a communication device 59 which when activated enables the micro-controller 57 to read the measures of the distance sensor 54 and orientation sensor 62 and communicated these measures. In one embodiment, the measures are communicated directly to the controller 20 and in another embodiment, the measures are communicated to the portable user device 61.

The communication device 59 that enables user interaction on the measurement tape enclosure 56 is preferably implemented as one or more buttons 59a and a display 59b. The measuring tape 53 may preferably also comprise a boost converter to provide the necessary power boost when the circuit is driven from batteries providing a voltage below the needed.

In the present context, an intelligent measurement tape may be implemented as a distance sensor including a physical measuring strip 55 as explained elsewhere in the application. This specific embodiment is indeed very advantageous as an implementation of a physical strip makes it possible for a user to measure in an intuitive way that he/she is well-acquainted with.

It should however be noted that an intelligent measuring tape in the present application should generally be understood as a distance meter without necessarily including and involving a physical measuring strip. Such measuring sensors may e.g include conventional laser measuring devices or other non-contact sensors such as ultrasonic measuring devices

The distance measured by the measuring tape 53 may be acquired by a strip 55 (typically a metal strip, sometimes referred to as tape), visually showing the distance, but preferably also visually showing barcode like distance information readable by e.g. an optic sensor. The strip 55 is winded around a spool and when the strip (tape) 55 is extracted the spool is rotating around a fixed axis. Distance can also be measured based on this rotation.

The optical sensor scans the barcode and converts the scanning result into an electric signal. Using an optical sensor to scan the bar code markers on the measurement tape has the advantage of being low in cost and simple to implement however the precision is limited to the resolution of the bar code markers. Further, this method is also prone to error readings if dirt covers the tape. Accordingly, this method alone is not enough for robust and millimetre-precise distance acquisition.

A rotary sensor exists in different price ranges, sensing resolutions and are using different measuring methods, typically based on light or magnetism. The rotation can be detected using a disc with either holes or closely mounted magnetic poles which is detected using an opto sensor or Hall-Effect sensor. The output is a so-called quadrature signal showing the direction of rotation and the amount. An additional method of measuring spool rotation is called magnetic field angle sensor. This is based on the concept of Anisotropic Magneto-Resistive and requires a magnet to rotate just above an IC-component/rotation sensor chip.

In an embodiment, a dedicated rotary position sensor such as e.g. a 12-bit on-axis magnetic rotary position sensor with quadrature incremental and push-button output is used. This position sensor is used in combination with a mathematic model of the winded tape 55 describing the reduction of length of tape for each revolution the tape 55 is extracted due to the reduced radius of the winded tape 55. In an embodiment, the distance measurement is established by a combination of the rotary sensor and an alternative hereto, such as a barcode reader or the like. In the present context, and within the scope of the invention, a distance may be measured alternatively by means of non-contact measurement. In such an implementation, the distance would be measured e.g. by means of ultrasonic or laser measurement devices. In the case of a laser measurement device, the user of the intelligent measuring tape (now the intelligent measuring tape is without a physical tape) may simply activate the laser distance sensor by pointing at one end of the relevant measuring points (when measuring a kind of 1D measurement where the measuring tape device as such defines one end the distance to be measured and where the other endpoint is defined as the point at which the laser beam points). A corresponding orientation may also be measured by orientation sensors. The device, method and system will still work according to advantageous provisions of the invention where the obtained laser measure (as an alternative to the measure obtained via digital reading of the strip) is applied inventively in the communication with the automated cutter, i.e. by easily/effectively mapping 1D distance measures into a 2D cutting of a board to be cut. This is partly obtained by the invention's use of a number of single measured distances/linear measures and associated orientations into a 2D definition of how to cut the board. This is in particular advantageous as the orientations related to the measured distances are transferred to the controller with associated individual measured distances/individual linear measures.

The orientation sensor 62 can be implemented as an IMU (IMU; Inertial Measurement Unit) i.e. a MEMS (MEMS; Micro Electro-Mechanical System) e.g. comprising an accelerometer that is able to establish linear acceleration and a gyroscope that is able to establish angular velocity. A MARG (MARG; Magnetic, Angular Rate and Gravity) sensor is a hybrid IMU which also incorporates a magnetometer. By combining the output from the accelerometer and gyroscope of the IMU it is possible to obtain the orientation of the measuring tape enclosure 56 with respect to the gravitational field of the earth and a calibration starting point for the Z-axis. Using the additional MARG sensor allows the achievement of a complete orientation relative to the magnetic field of the earth and the direction of the gravity.

The MARG method is however not suitable if the distance sensor is based on the magnet/rotation sensor chip method described above in that the magnet may disturbed these measuring systems. The advantages of using the MARG sensor however, is that by the magnetometer hereof it is possible to compensate for a drifting Z axis and a relative Z axis orientation when starting up the measuring tape.

The sensors 54, 62 and micro-controller 57 are preferably PCB (PCB; Printed Circuit Board) mounted and located within a measuring tape enclosure 56. This enclosure is comprising the PCB, the spool of marked tape 55 and display 59b and buttons 59a and preferably, a magnet, attached to the spool, is positioned just above the rotation sensor chip. In an embodiment, the gap between the magnet and the rotation sensor chip is between 0.5 mm and 3 mm. The gap however, depends on the selected magnet hence a large and strong magnet allows a larger airgap. The optimal airgap can be found by adjusting the distance between the magnet and the rotary sensor. Preferably, the maximum allowed displacement of the rotational axis of the reference magnet from the center of the package is between 0.1 mm and 0.5 mm, preferably 0.25 mm when using a magnet with a diameter of 6 mm.

One non-limiting example of implementation is the spool goes into the bottom part of the enclosure and a magnet holder is attached to the spool. A bearing ball is used to lock the top part of the spool onto a rod attached to the bottom of the enclosure. This ensures that the rotation of the spool is stable while the magnet provides the necessary magnetic field for the rotation sensor.

The PCB is designed for providing the necessary sensing, processing and user interaction platform. The above-mentioned hardware components are connected on the PCB. In addition, the PCB is designed with decupling capacitors having multiple purposes where the main one is to keep the power supply source stable for the components.

A micro-controller 57 is needed in the measuring tape enclosure 56 to process the gathered sensor data and facilitate communication hereof. Preferably, the micro-controller 57 comprises a memory e.g. a flash memory which can be used for storing of sensed data prior to communication. The micro-controller 57 receives input from all of the sensors and buttons 59a and provide output to the display 59b, portable user device 61 and/or controller of the portable panel cutter 1.

The choice of communication method is in principle not important as long as the portable user device 61 and/or controller 20 facilitate communication according to such method. Wireless communication is preferred and comprises Bluetooth, WiFi and NFC. Since NFC is a near field technology which would reduce the working distance between the measuring tape 53 and the portable user device 61 and/or controller 20, it is not the preferred communication protocol. Communication via WiFi requires more power communication via Bluetooth which is why Bluetooth is preferred. The Bluetooth Low Energy platform is preferred over Bluetooth Classic since this is targeted IoT applications and the energy consumption is lower. The Bluetooth Low Energy platform is capable of detecting and handling errors in the link layer leaving the application layer focussing on data only. It should be mentioned, that the wireless communication channel may be bidirectional.

In the following, the present invention is described in an embodiment, where the measuring tape 53 is communicating with the controller 20 via a smartphone 61. This embodiment is the preferred embodiment of the invention, however should be limiting for the scope of protection in that several other elements than what is described below is also within the scope of the invention.

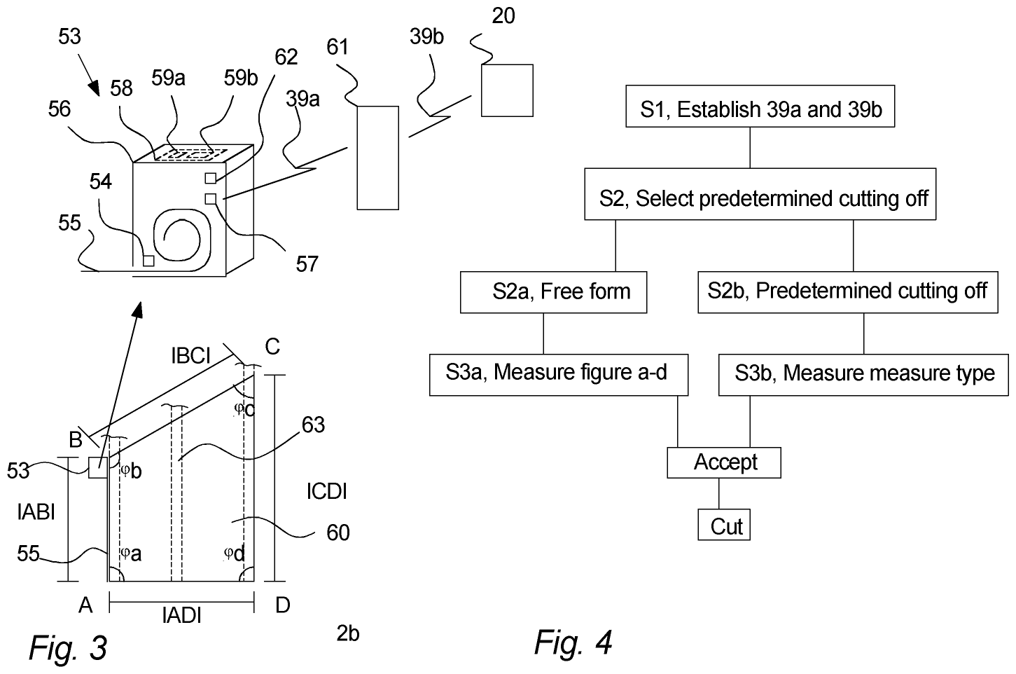

As mentioned, in the preferred embodiment of the invention, the measuring tape 53 is communicating i.e. providing measures to an application installed on a smartphone 61. With reference to FIG. 3 and FIG. 4 (Si), the communication channel 39a established between the measuring tape 53 and the smartphone 61 is established as a Bluetooth communication and the communication channel 39b between the smartphone 61 and the controller 20 is established a WiFi or mobile data connection. In this way, the working radius from the panel cutter is increased without increasing power consumption of the measuring tape (e.g. by using WiFi).

After having established the communication channel 39, the user needs to select a predetermined cutting off (FIG. 4, S2). The predetermined cutting off is selected either as a so-called free form cutting off (FIG. 4, S2a) of a so-called standard cutting off (FIG. 4, S2b). This selection is made via the application of the smartphone 62 which may prompt the user with the option of selecting between several predetermined cutting offs. It should be noted that as described below, the control of the panel cutter 1 including selecting predetermined cutting offs can be made via the measuring taper 53.

The free-form cutting off stand out in that after selecting this, the application does not prompt the user to input a specific measure. Instead, the user simply starts measuring the representation of the cutting off 12. This is illustrated with reference to FIG. 3 where the user needs to cover a representation of the cutting off defined by the fore points A, B, C and D. The user simply removably fixes the end of the measuring tape at point A and moves the enclosure 5 to point B, thereby extracting the tape. At point B the user activates the button 9a and thereby the linear measure between point A and point B is read and communicated to the smart phone. Next step is to removably fix the end of the measuring tape at point B and move the enclosure 5 to point C, where button 9a again is activated. Upon activation of button 9a, the linear measure between point B and point C is read and communicated to the smartphone. In addition, the angle φb is also read and sent to the smartphone. In the same way the linear measure between point C and point D, between point D and point A and angle (pc and angle φd are read and communicated.

It should here be noted that the linear measure between point A and point B may also, in within the provisions of the invention by established by a non-contact distance measuring device, e.g. by means of a laser measurement device. The skilled person would of course in such a situation not need to have a measurement device including a physical strip (tape) by simply operate the non-contact measurement device as he or she is used to in order to establish the relevant distances and the transmit them to be processed by the controller of the system into the desired 2 or 3D cut of the board. This also applied to any embodiment described in the present application as the inventive application of a remote measurement is advantageous, being applied with a measuring tape including a physical measuring tape or not.

The starting position of measuring the representation of the cutting off 12 is not essential. When receiving the measurements, the controller 20 (or user device 61) simply calculates a layout of how the measured representation can be cut on the board to be cut 42. Typically, if the layout includes a straight line, this line is placed along one side of the board to be cut to reduce cutting time.

It should be noted, that if the measured representation cannot be cut on one board to be cut 42, e.g. if this is not a whole board because previous cutting offs has been made hereof, the panel saw 1 may on its own determine how to divide the measured representation into several cutting offs made from several boards to be cut 42. If it is established, that more than one board to be cut 42 is required, the controller 20 via the user device 61 or the measuring tape 53 e.g. via the display 59b prompt the user to establish a measure of distance between fastening points such as laths 63 in a gypsum wall.

Further it should be noted, that the angles are measured, but not necessarily used. This is especially true, if a predetermined cutting off which is not the free form is selected. In the free form the same angle off-set can be deduced from each measured angle, so that the angle measurements in some embodiments are not used.

In an embodiment, it is possible, on the screen of the smartphone 61 to see the measures as they are received from the measuring tape 53. When all measures are received, the user has the possibility of reviewing a digital representation of the cutting off 60 to be made and if required modify the digital representation. The modification can be made either by dragging a point to a desired location or manually (including using voice) adjust one of the linear measures or angles.

When the user accepts the received measures (FIG. 4, S4), the user initiates the cutting of a cutting off in the board to be cut 42, that covers the representation of the cutting off 60. The initiation of the cutting (FIG. 4, S5) can be made manually by pushing a virtual button on the screen of the smartphone, a button 59a on the measuring tape 53 or via a voice command. Upon activation, the automated panel cutter 1 cuts in the board to be cut 42 the cutting off as represented digitally on the screen of the smartphone 61.

A particular advantageous feature of an embodiment is the feature that allows the application on the smartphone 61 to find the last linear measure (in the example of FIG. 3 the length from point D to point A) and the angle (pd. (pa may be determined before with respect to calibration point, but a new calculation with respect to D, may be done. This is possible because the coordinates of point A and the last point measured in the above example point D is known and therefore it is possible for the application on the smartphone 62 to calculate the length of this line along with the angle φd. The calculation can be based on measurements of lines between point A and B, point B and C and point C and D. This feature can be activated e.g. by activating (e.g. by a double click) the button 39a, such signal received by the smartphone 61 may be interpreted either as the final measure is made and sent or as the last line is the line between the latest registered point and the first registered point.

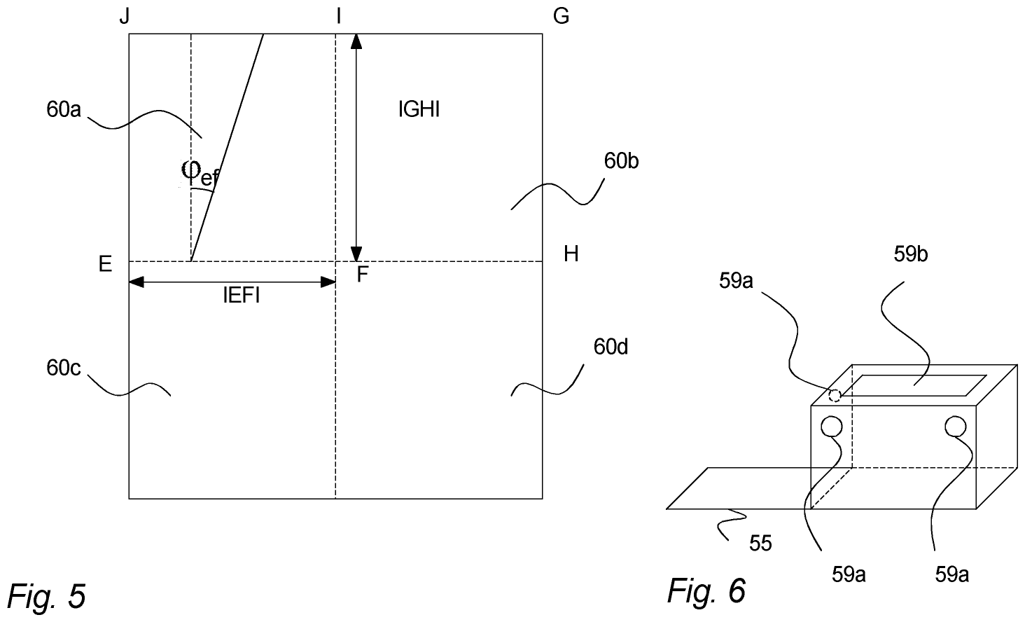

As mentioned above, the free-form cutting off stand out from alternatives hereto. These alternatives are geometry specific cutting offs and may be defined by one or several predetermined cuts made by the automated panel cutter 1. Examples of such predetermined cutting offs could be e.g. a straight cut that made to divide the board to be cut in two parts. In this example, it may be irrelevant where the measure is made on the representation of the board 60 to be cut. Hence, a straight cut predetermined cutting off is selected, the user is promted to provide a measure as to how far from one end of the board to be cut the cut should be made (see FIG. 5). If the width of the board to be cut 42 equals the width of the representation of the cutting off 60 i.e. is the same as the distance between point E and point F, only one cut is needed to make a cutting off covering the representation of the cutting off 60a.

When the user selects the straight predetermined cutting off (FIG. 4, 2b), he may be asked if the measure to be made is the measure of the part of the board to be cut 42 that is not to be used or is the cutting off that is to be used. Further, the user is able to select from which end of the board to be cut the measure should be made and following which end should be the cutting off that is to be used. This of course can also be modified when the measure is provided to the smartphone 61 before the user initiates the cutting in the same was as described above.

Therefore, a predetermined straight end cutting off can be selected is defined by the measure type “end”. Thus, this cutting off only requires one measure and it does not matter if the measure is taken from the bottom or top of the board (left and right sides are the same to establish a straight cut). Accordingly, a straight end and straight side cutting off can be selected only requiring one measure. In some situations, e.g. when cutting is made in a new board, it makes no difference if the measure is taken from the top or bottom. The user might select an end over the default end if e.g. one end of the board to be cut is damaged.

When having selected the predetermined end cutting off (or predetermined side cutting off) only on measuring type i.e. the distance from end to where the cut should be (or from one side to where the cut should be). The measure for this measuring type is made as described above with the respect to the free-form cutting off i.e. the end of the tape 55 is removably fixed to a point on the line between point E and point F and the enclosure 53 is moved to a point on the line between point I and point J. Obviously, there is a risk that such measure is not precise the same length as if the measure were made between specific point I and point E. However, because of the orientation sensor 62 and because the user selected end (or side) cutting, the application software can modify the measure if the angle (φef) received along with the measure is not 90 or 0 respectively. If this is not the case i.e. the linear measure is made with an angle between the stipulated line (representing the correct measure) and the solid line (representing the received measure), length of the received measure is longer due to the needed.

In case the communication is made directly to the controller 20 from the measuring device 53, one of the above-mentioned predetermined cutting offs are default and others can be selected via the communication device 59. In addition, either the portable panel cutter 1 may start cutting after receiving the last measure or upon activation in a predetermined sequence by the user of the communication device 59.

It is advantageous to be able to change mode of operation of the measuring tape 53 i.e. change between measuring source such as changing between extracting tape 55 and using a laser beam-based measuring device. Changing between mode of operation can be done e.g. by activation of one or more of the communication devices 59 e.g. in the form of buttons 59a. Hence, by a simple activation of one of the buttons or a predetermined sequence of activation of one or more of the buttons it is possible to change the way the measure is obtained by the measuring tape 53. In some embodiments, where a linear measure can be stabilised from a protrusion where a laser pointer beam can be reflected, this way of measuring may be the faster than extracting the tape 55. Such laser measurements may also be associated with an orientation measurement. However, where there are no protrusions, the tape 55 is the preferred way of measuring. Mode of operation may also be performed from the smartphone 61 based on input from a user.

Beside changing mode of operation, the buttons 59a can also be used for selecting one of the predetermined cutting offs. The display 59b may be used to follow the navigation between the predetermined cutting offs and when the needed predetermined cutting off is found and selected, the establishment of linear measures for the required measuring types can begin. The needed predetermined cutting off can be selected via an “OK” button of the enclosure 56 of the measuring tape 53.

Being able to change function of the buttons 59a located in the enclosure 56 of the measuring tape 53 leads to a very user-friendly measuring tape 53 in that any user can determine functions of buttons as he desires. For example, if the predetermined cutting off for end cut is used a lot by the user, then the user can configure one button 59a to select this particular predetermined cutting off just by pressing a button.

The reconfiguration can be established e.g. via the application on the portable user device 61 or e.g. by activating one or more buttons 59a in a predetermined sequence. In the latter situation, the function of the button 59a is now to scroll through the predetermined cutting offs and select one e.g. by pushing a button 59a which is defined as an “OK” button.

As illustrated on FIG. 6 the enclosure 56 of the measuring tape 53 is box shaped having six sides. Positioned in its working position i.e. the position when used for measuring as illustrated on FIG. 6 the upper side is the side comprising the display 59b. On FIG. 6 the side facing the user is equipped with a first and a second button 59a. In other embodiments less than or more than two buttons may be implemented. Having buttons on the upper part of a side adjacent to the side comprising the display 59b is advantageous in that the user can then operated the measuring tape 53 with one hand.

The buttons 59a illustrated on FIG. 6 may be used to configure the measuring tape 53 i.e. selecting mode of operation (laser or measuring tape), predetermined cutting off, etc. It should be mentioned, that buttons may be implemented on the opposite side as illustrated on FIG. 6 also on the upper part of that side.

Further, a button 59a may be implemented at the upper part of the side through which the tape 55 is extracted (illustrated by stipulated lines on FIG. 6) this location is advantageous sin that the thumb of the user is typically located at such button when extracting the tape 55. Therefore, it is easy for the user to register a measure by activating that button without moving his hands or fingers. In this way there is a reduce risk that the measuring tape enclosure 56 will move away from the desired measuring point.

In an embodiment a button is configured to be an erase or regret button. This function is advantageous in that it has the effect, that upon activation of this button, the previous command is undone. Hence, if a measure is wrong, by activating this button the measure is erased and a new can be made or if a wrong predetermined cutting off is made activating this button lest the user select another predetermined cutting off. It may furthermore be possible to scroll back to previous measures.

It should be mentioned, that when in this document a reference is made to “activation of a button” then this is a reference to an activation of the button as one or more pushes for shorter or longer periods of time, predetermined sequence of activation, etc.

In an embodiment, the portable user device 61 is used to select predetermined cutting off or group hereof and mode of operation. When the initial selections are made the remaining steps of cutting by the portable panel cutter 1 can be established from the measuring tape 53. This includes providing to the user information of which measure type that is needed (for a predetermined cutting off), the current measure established, etc.

In an embodiment, the selection of the mode of operation and predetermined cutting off can also be made via the measuring tape 53 and displayed to the user via the display 59b. In this embodiment, the portable user device 61 is more less reduce to a communication hub. With this said the same information and more may simultaneously be displayed on the display of the portable user device 61.

In an embodiment of the invention, a predetermined cutting off (may be referred to as a quick predetermined cutting off) is used to specify several cutting offs, the measures of which are defined by only a few measurements. This predetermined cutting off is selected if e.g. beam having one side attached to a ceiling is to be covered. The dimensions of the three remaining sides are measured by the measuring tape 53 and the length of the beam is measured and sent to the portable user device 61 as described above. Based on these measured, this predetermined cutting off are able to calculate and send measured to the portable panel cutter 1 based on which the portable panel cutter 1 can cut three individual cutting offs that is needed to cover the beam. Further, if the beam is longer that board to be cut 42, the portable panel cutter 1 can on its own cut the number of cutting offs that is needed to cover the beam completely.

It should be mentioned that in this embodiment as in other embodiments described in this document, the calculation of how the power cutter is cutting may be made in the controller 20 and in such embodiment the measuring tape 53 and/or the portable user device 61 is only sending required measure to the controller 20.

Another example of a so-called quick predetermined cutting off if a square is to be cut. Then by the measuring tape 53 one side is measured and send to the portable user device 61. Here or at controller 20 based on the received measure, the remaining three sides are automatically generated. Further, if two sides of a rectangle are measured, then the remaining two sides need not to be measured but can automatically be calculated by the controller 20 or the portable user device 61.

Further, in the free-form predetermined cutting off or any other predetermined cutting off are selected and the measurements provided by the measuring tape 53 does not define a closed geometric form i.e. the endpoint and the start point does not match, the information may be provided to the user. It is possible for the measuring/cutting system to perform this check in that the linear measures provided by the measuring tape is associated with orientation measurements.

It should be mentioned, that if e.g. a square is to be cut or if e.g. a width of a representation of a cutting off having to parallel sides is measured, the measure can be made any place along that side.

In an exemplary embodiment, the intelligent measuring tape provides for each measurement taken by the user at least two different measures one in each of at least two different orientations in space.

The portable automated power cutter is dynamic in the sense that two subsequent cuts are different from each other. This is at least true for the majority of cuttings.

From the above it is hereby clear that the present invention relates to an automated portable panel cutter system, an intelligent measuring tape and to a method of operating these system. The automated portable panel cutter system comprises or communicates with a measuring system. The measuring system comprises an intelligent measuring tape 53 comprising a measuring interface (distance 54 and orientation sensors 62) and a communication interface (buttons 59a, display 59b and data communication interface) controlled by a micro-controller 57. Thereby, a user is able to select mode of operation and one of a plurality of predetermined cutting offs via the measuring tape 53.

The measuring system further comprises a portable user device 61, which may be a smartphone, comprising an application via which the user can make at least the same selection as can be made via the intelligent measuring tape 53. In addition, the portable user device 61 may enable the use to view, edit, store, etc. information received from the measuring tape 53.

Accordingly, the measuring system, upon measuring a representation of a cutting off 60, is communicating the measures and how these are to be cut in a board to be cut 42 by the portable panel cutter system. The measuring tape 53 is communicating with the portable user device 61 or directly to the controller 20 of the automated panel cutter 1. In the former embodiment, the portable user device 61 passes the information received from the measuring tape 53 on to the controller 20 of the portable panel cutter 1. Hence, the cutting performed by the portable automated panel cutter is controlled either from measuring tape 53 and/or from the portable user device.

### LIST

1. Portable automated cutter

2. Frame profile
a. First frame profile
b. Second frame profile
c. Third frame profile
d. Forth frame profile

3. Support frame

4. Inner support area

5. First carriage transmission part

6. Second carriage transmission part

7. Carriage

8. First carriage motor

9. Tool holder carriage

10. First tool holder drive part

11. Second carriage motor

12. Tool holder

13. Power cutter

16. First tool displacement means (motor)

19. Second tool displacement means (motor)

20. Controller

21. Board support

22. Third carriage transmission part

23. Board support fixation

24. Board guide steering

25. Board guide
a. First guide area
b. Second guide area

26. First carriage bearing

37. Fourth carriage transmission part

39. Data communication channel

40. First carriage bearing receiver

41. Second carriage bearing receiver

42. Board to be cut

45. First longitudinal opening

46. Diagonal support

47. Electric wire from power cutter

48. Electric socket powering the power cutter

49. Energy storage

50. Utility grid

51. Motor power supply cables

52. Power supply cable

53. Intelligent measuring tape

54. Distance sensor

55. Tape

56. Enclosure

57. Micro-controller

58. User interface

59. Communication device
a. Button
b. Display

60. Representation of a cutting off

61. Portable user device

62. Orientation sensor

63. Fastening points such as laths

X. First direction

Y. Second direction

Z. Third direction

φ. Angle of rotation

1. A method of remote control of an automated cutter comprising a power cutter,
wherein a position of the power cutter in X, Y and Z directions relative to a board to be cut and an orientation in an angle φ around the Z direction, are controlled by a controller, controlling motors based at least partly on input provided by a user via an intelligent measuring tape,
wherein the method comprises the steps of:
establishing a wireless communication channel between the intelligent measuring tape and the controller, wherein the intelligent measuring tape comprising comprises:
a distance sensor establishing information of a distance,
an orientation sensor communicating with the micro-controller establishing information of orientation of the distance,
a micro-controller communicating with the distance sensor(s) and with the controller, and
a user interface comprising a communication element;
establishing, by the distance sensor, a linear measure of the distance;
facilitating, by activating the communication element, wireless communication of the established linear measure from the micro-controller to the controller, and
upon receiving the established linear measure, controlling, by the controller, controls the motors and the power cutter according to the established linear measure resulting in an automatic cut of a cutting off in the board to be cut matching the representation of the cutting off

2. The method according to claim 1, further comprising the steps of:
establishing a wireless communication channel between the intelligent measuring tape and the controller, wherein the intelligent measuring tape comprises:
a distance sensor establishing information of a length of a tape extracted from an intelligent measuring tape enclosure,
a micro-controller communicating with the distance sensor(s) and with the controller,
an orientation sensor communicating with the micro-controller establishing information of orientation of the intelligent measuring tape enclosure (56), and
a user interface comprising the communication element;
extracting the tape from the intelligent measuring tape enclosure along at least one part of a representation of a cutting off;
establishing, by the distance sensor, a linear measure of the length of the extracted tape;
facilitating, by activating the communication element, wireless communication of the established linear measure from the micro-controller to the controller; and
upon receiving the established linear measure, controlling, by the controller, the motors and the power cutter according to the established linear measure resulting in the automatic cut of the cutting off in the board to be cut matching the representation of the cutting off.

3. The method according to claim 1, further comprising the step of:
assembling a support frame defining an inner support area, the support frame being releasably assembled by a plurality of frame profile;
movably mounting a carriage to a first and second of the plurality of frame profiles of the support and thereby being movable over the inner support area; and
releasably mounting a power cutter to the carriage.

4. The method according to claim 1, wherein the distance measurement and the orientation measurement are measured and stored in a data memory simultaneously upon activating the communication element.

5. The method according to claim 1, wherein the wireless communication channel from the intelligent measuring tape to the controller is established via a portable user device.

6. The method according to claim 1, further comprising the step of:
prompting, via a portable user device or via the intelligent measuring tape, the user for required measurements.

7. The method according to claim 1, wherein the measure of at least one of required measure types of a selected predetermined cutting off is derived from one or more of previous measures.

8. The method according to claim 1, wherein a selection of predetermined cutting offs includes specifying if the cutting off is a right-angled geometric shape.

9. An intelligent measuring tape comprising:
a distance sensor establishing a non-contact distance;
a micro-controller communicating with the distance sensor and with a controller of an automated cutter;
an orientation sensor communicating with the micro-controller establishing information of orientation of the distance; and
a user interface comprising a communication element,
wherein the distance sensor is implemented as an optical sensor, a rotary sensor,. or magnetic distance sensor.

10. An intelligent measuring tape, comprising:
a distance sensor establishing information of a length of a tape extracted from an intelligent measuring tape enclosure;
a micro-controller communicating with the distance sensor and with a controller of an automated cutter;
an orientation sensor communicating with the micro-controller establishing information of orientation of the intelligent measuring tape enclosure; and
a user interface comprising a communication element,
wherein the distance sensor is implemented as an optical sensor, a rotary sensor, or magnetic distance sensor.

11. (canceled)

12. (canceled)

13. The intelligent measuring tape according to claim 9, further comprising:
a data memory communicating with the micro-controller.

14. (canceled)

15. (canceled)

16. The intelligent measuring tape according to claim 9, wherein a portable user device comprises a user interface via which a user is allowed to review and modify measurements received from the intelligent measuring tape before the user via the portable user device allows the controller to initiate a cutting operation.

17-21. (canceled)

22. The intelligent measuring tape according to claim 9, wherein the communication device is implemented as a plurality of buttons and functions of the plurality of buttons are reconfigurable.

23-29. (canceled)

30. A measuring system comprising an automated cutter, a portable user device, and an intelligent measuring tape, the measuring system comprises:
a measuring interface implemented as a distance sensor and an orientation sensor as part of the intelligent measuring tape;
a first communication device as part of the intelligent measuring tape, and
a second communication device as part of the portable user device,
wherein the intelligent measuring tape facilitates control of dimensions of a cutting off to be cut by the automated cutter.

31. The measuring system according to claim 30, wherein the dimension control includes providing measures obtained by the intelligent measuring tape to the automated cutter via the portable user device.

32. The measuring system according to claim 30, wherein the automated cutter is started from the intelligent measuring tape or from the portable user device.

33. An automated cutter system comprising an automated cutter and an intelligent measuring tape,
wherein:
the intelligent measuring tape comprises:
a distance sensor establishing information of a distance;
a micro-controller communicating with the distance sensor and with a controller of the automated cutter;
an orientation sensor communicating with the micro-controller establishing information of orientation of the distance; and
a user interface comprising a communication element, and
the controller is configured for automatically starting and controlling cutting operation of a power cutter removably connected to the automated cutter based on measures received from the intelligent measuring tape.

34. An automated cutter system comprising an automated cutter and an intelligent measuring tape,
wherein:
the intelligent measuring tape comprises:
a distance sensor establishing information of a length of a tape extracted from an intelligent measuring tape enclosure;
a micro-controller communicating with the distance sensor and with a controller of the automated cutter;
an orientation sensor communicating with the micro-controller establishing information of orientation of the intelligent measuring tape enclosure; and
a user interface comprising a communication element, and
the controller is configured for automatically starting and controlling cutting operation of a power cutter removably connected to the automated cutter based on measures received from the intelligent measuring tape.

35. (canceled)

36. The method according to claim 1, wherein the portable automated cutter is at least partly collapsible.

37. The method according to claim 1, wherein a cutting tool of the power cutter is a sawblade or a disc grinder disc.
